(19) United States
(12) Patent Application Publication
(10) Pub. No.: US 2024/0264039 A1
(43) Pub. Date: Aug. 8, 2024

(54) METHOD FOR CALCULATING COUPLED LUBRICATION AND DYNAMICS CHARACTERISTIC PARAMETERS OF FLANGED BEARING

(71) Applicant: HARBIN ENGINEERING UNIVERSITY, Harbin (CN)

(72) Inventors: Bin ZHAO, Harbin (CN); Jiahao SHI, Harbin (CN); Xiqun LU, Harbin (CN); Wanyou LI, Harbin (CN); Hanzhang XU, Harbin (CN); Xuan MA, Harbin (CN); Xiujiang SHI, Harbin (CN); Zhijun SHUAI, Harbin (CN); Yibin GUO, Harbin (CN); Donghua WANG, Harbin (CN); Hongliang LI, Harbin (CN); Lieyi DONG, Harbin (CN)

(73) Assignee: HARBIN ENGINEERING UNIVERSITY, Harbin (CN)

(21) Appl. No.: 18/291,586

(22) PCT Filed: Feb. 28, 2023
(86) PCT No.: PCT/CN2023/078759

§ 371 Date: Jan. 24, 2024

(30) Foreign Application Priority Data
Dec. 27, 2022 (CN) 202211684221.6

(51) Int. Cl. G01M 13/04; G01L 5/00

(52) U.S. Cl. CPC G01M 13/04; G01L 5/0009

(57) ABSTRACT

A method for calculating coupled lubrication and dynamics characteristic parameters of a flanged bearing includes three modules: a flanged bearing journal-trust thermal elastohydrodynamic coupled lubrication module, a flanged bearing dynamics characteristic parameter calculation module and a flanged bearing relative position feedback module. It considers the joint motion law of the journal part and the thrust part, and also considers the flow, pressure and thermal continuity conditions of the lubricant on the common boundary of the flange bearing, and finally forms the journal-thrust transient coupled lubrication analysis method of the flange bearing. On the basis, considerations are further given to the stiffness and the damping characteristics of the flanged bearing under the coupled effect, thereby achieving accurate simulation of the dynamic and the tribology performance of the flanged bearing, and solving the problem of lubrication failure of the flanged bearing.

### CROSS REFERENCE TO THE RELATED APPLICATIONS

This application is the national phase entry of International Application No. PCT/CN2023/078759, filed on Feb. 28, 2023, which is based upon and claims priority to Chinese Patent Application No. 202211684221.6, filed on Dec. 27, 2022, the entire contents of which are incorporated herein by reference.

### TECHNICAL FIELD

The present disclosure belongs to the technical field of diesel engine simulation, and relates to a method for calculating coupled lubrication and dynamics characteristic parameters of a flanged bearing.

### BACKGROUND

A crankshaft-bearing system constitutes a key component of a diesel engine, so its lubrication performance will directly affect the reliability and service life of the diesel engine. Generally positioned at a tail end of a crankshaft, a flanged bearing is an important part that radially supports the crankshaft and prevents the crankshaft from axial movement, easily resulting in a very small oil clearance, severe operating conditions for lubrication, and a high-temperature ablation phenomenon usually accompanied, therefore, the service life of the diesel engine is shortened.

Currently, there are some studies on flanged bearing in China, but these studies usually simplify the flanged bearing into a thrust bearing. In addition to a trust surface of a flanged bearing, an actual ablation position involves a bushing surface of a journal part close to a thrust side, and this phenomenon cannot be explained by the simplified analysis of a journal or thrust bearing alone. Furthermore, dynamics characteristics of the flanged bearing vary with the operation of the crankshaft, and the stability of the flanged bearing is accordingly affected.

Therefore, those skilled in the prior art are in an urgent need to provide a method for calculating coupled lubrication and dynamics characteristic parameters of a flanged bearing, build a simulation model that gives comprehensive consideration to a journal-trust thermal elastohydrodynamic lubrication and dynamics characteristics of the flanged bearing, and establish relationship between pressure coupling and thermal coupling of a journal-thrust part of the flanged bearing, so as to solve the existing problems in the prior art, that is, lubrication mechanism generating ablation are explained more accurately, the lubrication and dynamics rules of the flanged bearing in a transient process are disclosed, and theoretical support is provided for ablation failure and instability analysis of the flanged bearing.

### SUMMARY

In view of the forgoing technical problems, the present disclosure provides a method for calculating coupled lubrication and dynamics characteristic parameters of a flanged bearing, builds a simulation model that gives comprehensive consideration to a journal-trust thermal elastohydrodynamic lubrication and dynamics characteristics of the flanged bearing, and establishes relationship between pressure coupling and thermal coupling of journal and thrust parts of the flanged bearing, so that lubrication mechanism generating ablation are explained more accurately, the lubrication and dynamics rules of the flanged bearing in a transient process are disclosed, and theoretical support is provided for ablation failure and instability analysis of the flanged bearing.

In order to achieve the above objective, the present disclosure adopts the following technical solution:

a method for calculating coupled lubrication and dynamics characteristic parameters of a flanged bearing, including the following steps:
S1. obtaining structural parameters and operating conditions of a flanged bearing;
S2. setting a time t;
S3. calculating and obtaining oil film load capacity by using a flanged bearing journal-trust thermal elastohydrodynamic coupled lubrication module;
S4. after completing the S3, calculating stiffness damping by using a flanged bearing dynamics characteristic parameter calculation module;
S5. after completing the S4, determining whether a working cycle of an internal combustion engine has been completed by using a flanged bearing relative position feedback module, outputting and saving working characteristic parameter results of the flanged bearing when the working cycle has been completed, and directly proceeding to S6 when the working cycle is not completed yet; and
S6. calculating radial and axial displacements of the flanged bearing according to a load at the corresponding moment, updating a calculation domain and network of a thrust part, and continuing to perform calculation by taking a relative position of each bearing at a next moment as an input parameter of the flanged bearing journal-trust thermal elastohydrodynamic coupled lubrication module and the flanged bearing dynamics characteristic parameter calculation module.

In the above method, optionally, the S3 specifically includes: calculating oil film thicknesses of the journal part and the thrust part according to the inputted structural parameters and operating conditions of the flanged bearing:
introducing a Reynolds averaged equation that gives consideration to an axial velocity on the basis of obtaining the oil film thicknesses, solving the Reynolds averaged equation, adopting a finite difference method to calculate oil film pressure distributions of the journal part and the thrust part, and performing loop iterations until pressure convergence conditions are met, and pressure boundary conditions follow Reynolds boundary conditions;
adopting the finite difference method to solve three-dimensional energy equations of the journal part and the thrust part respectively, a heat conduction equation of a bearing shell of the same, and the boundary conditions include: oil inlet end temperatures of the journal part and the thrust part are given oil inlet temperatures; regarding an exterior of a bearing shell as convective heat transfer conditions with an environment; calculating heat at an oil outlet end of the journal part and heat at an inner diameter area of the thrust part according to heat flow continuity conditions; and updating in each loop iteration and performing loops until the temperature meets the convergence conditions;
adopting a deformation matrix method to calculate an oil film pressure, calculating thermal deformation at each node of the journal part and the thrust part according to the obtained oil film pressure, introducing the thermal deformation into oil film thickness equation, and repeating the previous oil pressure calculation until the thermal deformation meets the convergence conditions; and
adopting an elastic deformation matrix to calculate elastic deformation at each node of the journal part and the thrust part based on the current pressure, introducing the elastic deformation into the oil film thickness equation and repeating the previous oil pressure calculation, in which case, introducing the boundary conditions: that is, the oil film pressure on an end face of a thrust side of the journal part and the oil film pressure at an inner diameter of the thrust part meet the heat flow and pressure continuity conditions, performing loop calculation until the elastic deformation meets the convergence conditions, and integrating the oil film pressures to obtain an oil film load capacity.

In the above method, optionally, the oil film thickness equation of the journal part is expressed as follows:

$${h}_{J} = c ( 1 ← ε cos θ ) + ( y + V Δ t ) {γ}_{j} cos ( 0 - ϕ - {α}_{r} ) + {δ}_{JE} + {δ}_{JT} ;$$

in the equation, c is a radius clearance, ε represents an eccentricity, θ represents a position angle of the bearing, δ_{JE} represents elastic deformation of the journal part, δ_{JT} represents a thermal deformation of the journal part, φ represents an attitude angle of a central section, γⱼ is an inclination angle of a journal of a main bearing shell; and αᵣ is an angle between the project of a journal axis and an eccentric distance;
the oil film thickness equation of the thrust part is expressed as follows:

$${h}_{T} = {h}_{p} + r sin ( {θ}_{p} ) + {δ}_{TE} + {δ}_{TT}$$

in the equation, θₚ is a circumferential inclination angle of a single shell, hₚ an average oil clearance, r is a radial coordinate, δ_{TE} is elastic deformation, and δ_{TT} is thermal deformation;
a Reynolds equation of the journal part expressed is:

$$\frac{\partial }{\partial x} ( {ϕ}_{x} \frac{{h}_{J}^{3}}{η} \frac{\partial {P}_{J}}{\partial x} ) + \frac{\partial }{\partial y} ( {ϕ}_{y} \frac{{h}_{J}^{3}}{η} \frac{\partial {P}_{J}}{\partial y} ) = 6 ω r ( {ϕ}_{c} \frac{\partial {h}_{J}}{\partial x} σ \frac{\partial {φ}_{s}}{\partial x} ) + 12 {ϕ}_{c} \frac{\partial {h}_{J}}{\partial t} + 6 {ϕ}_{c} \frac{\partial ( ρ h )}{\partial y} + 6 V σ \frac{\partial ( ρ {ϕ}_{s} )}{\partial y} ;$$

in the equation, ϕₓ, ϕ_{y}, ϕₛ and ϕ_{c} are x-direction and y-direction pressure flow factors, a shear flow factor and a contact factor, respectively, introduced when a roughness is considered, hⱼ is oil film thickness of the journal part, η is viscosity of a lubricating medium, p_{J} is oil film pressure distribution of the journal part, ω is a relative rotation of the journal and the bearing shell, V is an axial velocity of the journal, r is an inner diameter of the bearing, x is an x-direction position of the bearing, y is a y-direction position of the bearing, and t is a time.
a Reynolds equation of the thrust part is expressed as:

$$\frac{\partial }{{r}_{T} \partial x} ( {ϕ}_{θ} \frac{{h}_{T}^{3}}{{r}_{T} η} \frac{\partial {P}_{T}}{\partial θ} ) + \frac{\partial }{\partial r} ( {ϕ}_{y} \frac{{h}_{T}^{3}}{η} \frac{\partial {P}_{T}}{\partial r} ) = 6 ω r ( {ϕ}_{θ} \frac{\partial {h}_{T}^{3}}{\partial θ} σ \frac{\partial {ϕ}_{s}}{\partial θ} ) + 12 {φ}_{c} \frac{\partial {h}_{T}}{\partial t} ;$$

in the equation, ϕ_{θ} and ϕᵣ are pressure flow factors in circumferential and radial directions, respectively, introduced when a roughness is considered, r_{T} is a radial position of a trust surface, h_{T} is oil film thickness of the thrust part, p_{T} represents the oil film pressure distribution of the thrust part, θ is a circumferential position of the bearing, and the rest variables are the same as those of the journal part.

In the above method, optionally, the heat flow continuity conditions are expressed as:

$${( v \frac{\partial {T}_{j}}{\partial z} )}_{j , m} = - {( {U}_{r} \frac{\partial {T}_{th}}{\partial r} )}_{j , m} ;$$

$$v \frac{{T}_{j , m} - {T}_{j , m - 1}}{Δ z} = {U}_{r} \frac{{T}_{j , m + 1} - {T}_{j , m}}{Δ r} ;$$

$${T}_{j , m} - \frac{{U}_{r} Δ {zT}_{j , m + 1} + v Δ {rT}_{j , m - 1}}{v Δ r + {U}_{r} Δ z} ;$$

in the equation, T_{j,m} is an oil film temperature at an interface between the journal part and the thrust part, j is a circumferential position, m is an axial position of the journal part and a radial position of the thrust part, Uᵣ is a radial flow rate of the oil film of the thrust part, v is an axial flow rate of the oil film of the journal part, Δz is an axial unit length of the journal part, and Δr is a radial unit length of the thrust part;
the thermal deformation and the elastic deformation calculated by the deformation matrix method can be expressed as:

$$\{ \begin{matrix}{δ}_{E} ( θ , z ) & = {\int }_{0}^{ROW} {\int }_{0}^{COL} {DE}_{θ , z}^{{θ}^{′} , {z}^{′}} p ( {θ}^{′} , {z}^{′} ) d θ dz \\ {δ}_{T} ( θ , z ) & = {\int }_{0}^{ROW} {\int }_{0}^{COL} {DE}_{θ , z}^{{r}^{′} , {θ}^{′} , {z}^{′}} T ( {r}^{′} , {θ}^{′} , {z}^{′} ) d θ dz\end{matrix} ;$$

in the equation, COL represents a number of grids in a circumferential direction, ROW represents a number of grids in an axial direction, corresponding to a number of grids in a radial direction of the thrust part; DE_{θ,z}^{0′,z′} is the elastic deformation matrix, representing elastic deformation generated at a node (θ,z) by a pressure on an action unit of a node on an inner hole surface (θ′,z′) of the bearing shell; DT_{θ,z}^{θ′,z′} is a thermal deformation matrix, representing thermal deformation generated at the node (θ,z) by a temperature rise of an action unit of a node (θ′,z′) of the bearing shell material; Δθ is a circumferential unit length; and Δz is an axial unit length, corresponding to the radial unit length of the thrust part;
the flow and pressure continuity conditions are expressed as;

$${( \frac{{h}_{J}^{3}}{12 η} \frac{\partial {P}_{hJ}}{\partial z} )}_{j , m} = {( - \frac{{h}_{T}^{3}}{12 η} \frac{\partial {P}_{hT}}{\partial r} )}_{j , m} ;$$

$$\frac{{h}_{J}^{3}}{12 η} \frac{{P}_{j , m} - {P}_{j , m - 1}}{Δ z} = \frac{{h}_{T}^{3}}{12 η} \frac{{P}_{j , m + 1} - {P}_{j , m}}{Δ r} ;$$

$${P}_{j , m} = \frac{Δ {zh}_{J}^{3} {P}_{hT ( j , m + 1 )} + Δ {rh}_{J}^{3} {P}_{hJ ( j , m - 1 )}}{Δ {zh}_{T}^{3} + Δ {rh}_{J}^{3}} ;$$

in the equation, P_{j,m} is an oil film pressure at the interface between the journal part and the thrust part, j is a circumferential position, m is an axial position of the journal part and a radial position of the thrust part, h_{T} is the oil film thickness of the thrust part, h_{J} is oil film thickness of the journal part, Δz is an axial unit length of the journal part, and Δr is a radial unit length of the thrust part.

In the above method, optionally, in the S4, deducting a Reynolds disturbance equation under a coupled effect after obtaining the oil film load capacity through calculation, solving and calculating to obtain a disturbance radial force and a disturbance axial force, and calculating the stiffness damping of each part according to a coupled stiffness damping matrix.

In the above method, optionally, the Reynolds disturbance equation for calculating the coupled disturbance force is expressed as follows:

$$\frac{\partial }{R \partial θ} ( {ϕ}_{θ} \frac{{h}_{J}^{3}}{12 μ} \frac{\partial {p}_{ξ J}}{R \partial θ} ) + \frac{\partial }{\partial z} ( {ϕ}_{z} \frac{{h}_{J}^{3}}{12 μ} \frac{\partial {p}_{ξ J}}{\partial z} ) = \{ \begin{matrix}- \frac{\partial }{R \partial θ} ( {ϕ}_{θ} \frac{{h}_{J}^{2}}{4 μ} \frac{\partial {p}_{ξ J}}{R \partial θ} sin θ ) + \frac{\partial }{\partial z} ( {ϕ}_{z} \frac{{h}_{J}^{2}}{4 μ} \frac{\partial {p}_{ξ J}}{\partial z} sin θ ) + \frac{ω R}{2} cos θ : & ξ J = x \\ - \frac{\partial }{R \partial θ} ( {ϕ}_{θ} \frac{{h}_{J}^{2}}{4 μ} \frac{\partial {p}_{ξ J}}{R \partial θ} cos θ ) + \frac{\partial }{\partial z} ( {ϕ}_{z} \frac{{h}_{J}^{2}}{4 μ} \frac{\partial {p}_{ξ J}}{\partial z} cos θ ) + \frac{ω R}{2} sin θ : & ξ J = y \\ 0 : & ξ J = z \\ cos θ : & ξ J = \dot{x} \\ sin θ : & ξ J = \dot{y} \\ 0 : & ξ J = \dot{z}\end{matrix} ;$$

$$\frac{\partial }{r \partial θ} ( {ϕ}_{θ} \frac{{h}_{T}^{3}}{12 μ} \frac{\partial {p}_{ξ T}}{r \partial θ} ) + \frac{\partial }{\partial r} ( {ϕ}_{r} \frac{{h}_{T}^{3}}{12 μ} \frac{\partial {p}_{ξ T}}{\partial r} ) = \{ \begin{matrix}0 : & ξ T = x \\ 0 : & ξ T = y \\ \frac{\partial }{r \partial r} ( \frac{{rh}_{T}^{2}}{4 μ} \frac{\partial {p}_{0}}{\partial r} ) + \frac{\partial }{r \partial θ} ( \frac{{h}_{T}^{2}}{4 μ} \frac{\partial {p}_{0}}{r \partial θ} ) : & ξ T = z \\ 0 : & ξ T = \dot{x} \\ 0 : & ξ T = \dot{y} \\ 1 : & ξ T = \dot{z}\end{matrix} ;$$

in the equation, [symbol] corresponds to a perturbation term of the journal part, ξT corresponds to a perturbation term of the thrust part, when ξ is x, y or z, it represents a displacement disturbance term in a horizontal, vertical or axial direction, respectively, and when ξ is \dot{x}, \dot{y} or ż, it represents a velocity disturbance term in a horizontal, vertical or axial direction, respectively; and
after calculating and obtaining the disturbance pressures through the Reynolds disturbance equation, integrating the disturbance pressures, and then determining coupled oil film stiffness and damping values of each part, with the specific expression as follows:

$${K}_{J} = \int {\int }_{J} \{ \begin{matrix}- cos θ \\ - sin θ \\ 0\end{matrix} \} \{ \begin{matrix}{p}_{x} & {p}_{y} & {p}_{z}\end{matrix} \} d {Ω}_{J} = [ \begin{matrix}Kxx & Kxy & Kxz \\ Kyx & Kyy & Kyz \\ 0 & 0 & 0\end{matrix} ] ;$$

$${C}_{J} = \int {\int }_{J} \{ \begin{matrix}- cos θ \\ - sin θ \\ 0\end{matrix} \} \{ \begin{matrix}{p}_{\dot{x}} & {p}_{\dot{y}} & {p}_{\dot{z}}\end{matrix} \} d {Ω}_{J} = [ \begin{matrix}Cxx & Cxy & Cxz \\ Cyx & Cyy & Cyz \\ 0 & 0 & 0\end{matrix} ] ;$$

$${K}_{T} = \int {\int }_{T} \{ \begin{matrix}0 \\ 0 \\ - 1\end{matrix} \} \{ \begin{matrix}{p}_{x} & {p}_{y} & {p}_{z}\end{matrix} \} d {Ω}_{T} = [ \begin{matrix}0 & 0 & 0 \\ 0 & 0 & 0 \\ Kzx & Kzy & Kzz\end{matrix} ] ;$$

$${C}_{T} = \int {\int }_{T} \{ \begin{matrix}0 \\ 0 \\ - 1\end{matrix} \} \{ \begin{matrix}{p}_{\dot{x}} & {p}_{\dot{y}} & {p}_{\dot{z}}\end{matrix} \} d {Ω}_{T} = [ \begin{matrix}0 & 0 & 0 \\ 0 & 0 & 0 \\ Czx & Czy & Czz\end{matrix} ] ;$$

in the equation, K_{J} and K_{T} correspond to radial and axial stiffness, respectively, and C_{J} and C_{T} correspond to radial and axial damping.

In the above method, optionally, in the S6, calculating the relative position of the crankshaft journal/thrust shoulder and the bearing shell at the next moment by using the three-dimensional motion equation, analyzing thermal elastohydrodynamic lubrication characteristics of a composite bearing shell at the next moment, and updating its lubrication characteristic parameters in real time;
solving the radial and axial displacements are solved, and further calculating the three-dimensional motion equations for the radial and axial positions at a next moment, with the equation expressed as:

$$\{ \begin{matrix}{W}_{y}^{t} + {P}_{y}^{t} * cos α + {P}_{z}^{t} * sin α = {ma}_{y}^{t} \\ {W}_{x}^{t} + {P}_{x}^{t} = {ma}_{x}^{t} \\ {W}_{z}^{t} + {P}_{z}^{t} * sin α + {P}_{z}^{t} * cos α = {ma}_{z}^{t}\end{matrix} ;$$

in the equation, Wₓ, W_{y} and W_{z} represent loads in axial, horizontal and vertical directions, respectively; Pₓ, P_{y} and P_{z} represent load capacities in axial, horizontal and vertical directions respectively; a represents an inclination angle of the journal; and aₓ, a_{y} and a_{z} represent acceleration in axial, horizontal and vertical directions, respectively.

As can be seen from the above technical solutions, the present disclosure provides a method for calculating coupled lubrication and dynamics characteristic parameters of a flanged bearing, and has the following beneficial effects compared with the prior art:

1. By giving full consideration to the coupled lubrication effects of the journal part and the thrust part of the flanged bearing shell, and combining the lubrication states of the journal part and the thrust part, the pressure and temperature distribution are more consistent with the actual situation.

2. By giving consideration to time-varying calculation domains of the axial velocity and the thrust part, a state of the flanged bearing at each moment can be more accurately reflected under the integrated movement of the journal part and the thrust part, and the lubrication performance of the flanged bearing under an actual time-varying load can be more accurately simulated.

3. By giving consideration to the influence of the coupled effect of the flanged bearing on the dynamic performance, the stiffness damping results are more consistent with the actual operating conditions, and the stability analysis of the flanged bearing is accordingly more accurate.

### BRIEF DESCRIPTION OF THE DRAWINGS

In order to more clearly illustrate the technical solution in embodiments of the present disclosure or in the prior art, a brief introduction to the accompanying drawings required for the description of the embodiments or the prior art will be provided below. Obviously, the accompanying drawings in the following specification are merely embodiments of the present disclosure. Those of ordinary skill in the art would also derive other accompanying drawings from these accompanying drawings without making inventive efforts.

FIG. 1 is a flowchart of a method for calculating coupled lubrication and dynamics characteristic parameters of a flanged bearing provided in the present disclosure.

FIG. 2 is a calculation flowchart of a flanged bearing journal-trust thermal elastohydrodynamic coupled lubrication module and a flanged bearing coupling dynamics calculation module provided in the present disclosure.

FIG. 3 is a flowchart of specific calculation methods of a flanged bearing journal-trust thermal elastohydrodynamic coupled lubrication module and a flanged bearing coupling dynamics calculation module provided in the present disclosure.

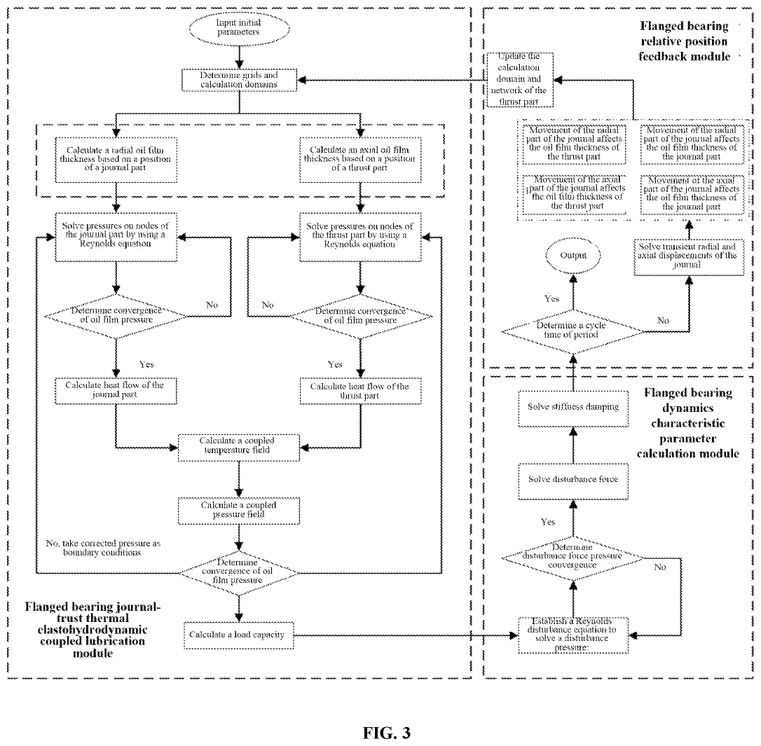

### DETAILED DESCRIPTION OF THE EMBODIMENTS

The technical schemes in the embodiments of the present disclosure will be described clearly and completely with reference to the accompanying drawings in the embodiments of the present disclosure. It is obvious that the embodiments described are merely some embodiments rather than all embodiments of the present disclosure. All the other embodiments obtained by those of ordinary skill in the art based on the embodiments in the present disclosure without creative efforts shall fall within the scope of protection of the present disclosure.

In the present disclosure, terms “comprising”, “including” or any other variants thereof are intended to cover the non-exclusive including, thereby making that the process, method, object or apparatus comprising a series of elements comprise not only those elements but also other elements that are not listed explicitly or the inherent elements to the process, method, merchandise or apparatus. Without further limitations, an element limited by the phrase “comprising/including a” does not exclude that there exists another same element in the process, method, merchandise or apparatus comprising the element.

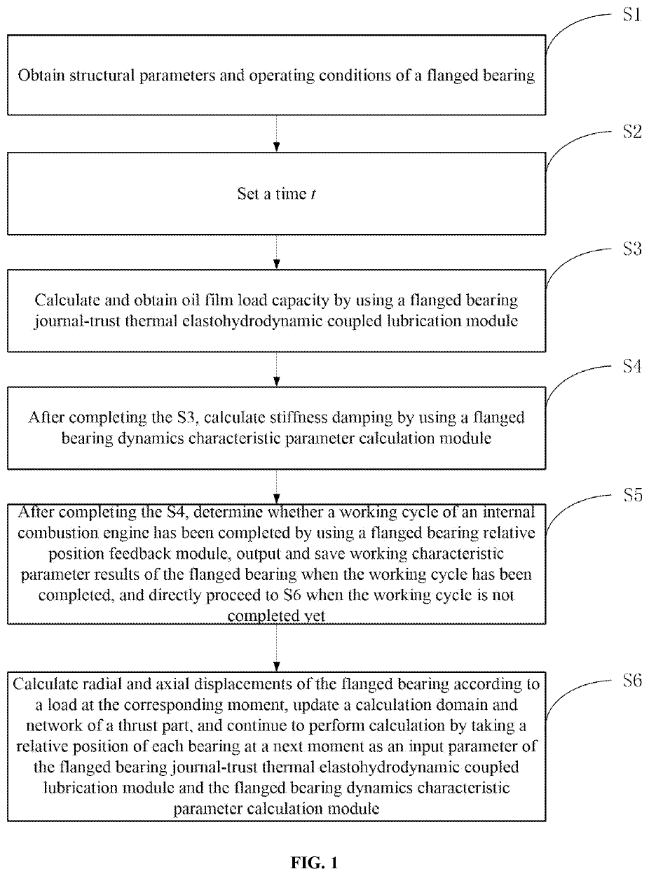

With reference to FIG. 1, the present disclosure provides a method for calculating coupled lubrication and dynamics characteristic parameters of a flanged bearing, including the following steps:
S1. obtaining structural parameters and operating conditions of a flanged bearing;
S2. setting a time t;
S3. calculating and obtaining oil film load capacity by using a flanged bearing journal-trust thermal elastohydrodynamic coupled lubrication module;
S4. after completing the S3, calculating stiffness damping by using a flanged bearing dynamics characteristic parameter calculation module;
S5. after completing the S4, determining whether to a working cycle of an internal combustion engine has been completed by using a flanged bearing relative position feedback module, outputting and saving working characteristic parameter results of the flanged bearing under the condition that it needs to complete the working cycle, and directly proceeding to S6 under the condition that it does not need to complete the working cycle; and
S6. calculating radial and axial displacements of the flanged bearing according to a load at the corresponding moment, updating a calculation domain and network of a thrust part, and continuing to perform calculation by taking a relative position of each bearing at a next moment as an input parameter of the flanged bearing journal-trust thermal elastohydrodynamic coupled lubrication module and the flanged bearing dynamics characteristic parameter calculation module.

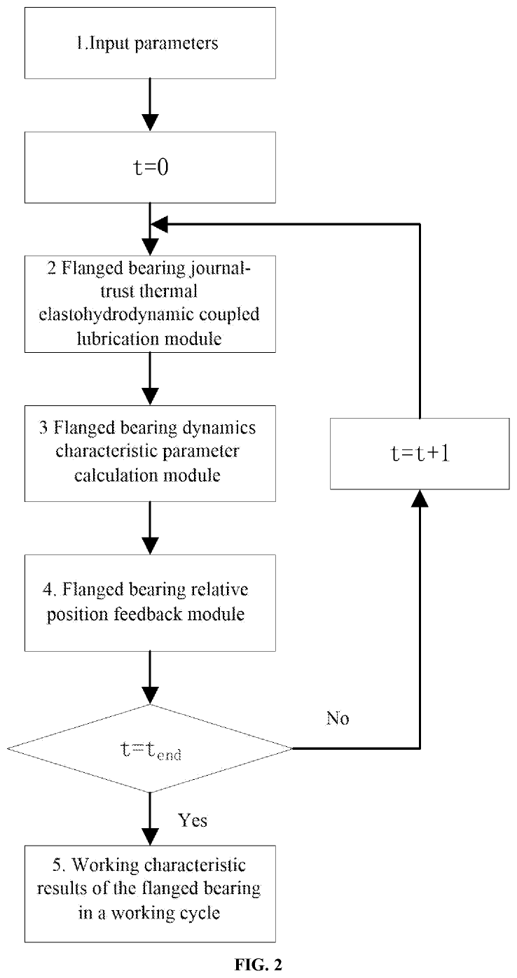

With reference to FIG. 2, further, global parameters are inputted into the flanged bearing journal-trust thermal elastohydrodynamic coupled lubrication module, and oil film thickness of a journal part is calculated and obtained according to an eccentricity and an attitude angle of the journal part input thereby; and an film thickness of a thrust part is calculated and obtained according to an initial assumed oil clearance and an inclination angle of a thrust pad of the thrust part;
a finite difference method is adopted to solve Reynolds equations of the journal and thrust parts, respectively by using Reynolds boundary conditions based on the oil film thickness, and an over relaxation method is adopted for loop calculation to increase a calculation speed until an oil film pressure meets convergence conditions and is outputted; and
temperature fields of the journal and thrust parts are solved, respectively, the finite difference method is adopted to solve a three-dimensional energy equation of an oil film area of the journal part and the thrust part each, and a heat conduction equation of a bearing shell area of the same, and the boundary conditions include: oil inlet end temperatures of the journal part and the thrust part are given oil inlet temperatures; an exterior of a bearing shell is regarded as convective heat transfer conditions with an environment, and an interior of the same is regarded as convective heat transfer conditions with the oil film; and heat at an oil outlet end of the journal part and heat at an inner diameter area of the thrust part are calculated according to heat flow continuity conditions. The over relaxation method is adopted for loop calculation to increase the calculation speed until a temperature meets convergence conditions and is outputted.

Then, a deformation matrix method is adopted to calculate and obtain thermal deformation of each node based on the obtained temperature fields, and the thermal deformation is substituted into oil film thickness equation to repeat the calculation of the above pressure and temperature until thermal deformation meets convergence conditions; elastic deformation calculation is carried out on the basis of the current temperature, the deformation matrix method is adopted to calculate and obtain elastic deformation of each node based on the current pressure field, the elastic deformation is substituted into the oil film thickness equation to repeat the calculation of the above pressure field, and boundary conditions are introduced in the calculation of the pressure field, namely, an oil film pressure on an end face of a thrust side of the journal part and an oil film pressure at an inner diameter of the thrust part meet the heat flow and pressure continuity conditions, and the loop calculation is performed until the elastic deformation meets the convergence conditions, at which moment a pressure distribution of each part of the flanged bearing at an initial given position is obtained; and
the oil film load capacity is calculated and obtained based on a distribution integral of oil film pressure, and a perturbation method is adopted to calculate and obtain a stiffness damping at an equilibrium position.

Further, the oil film thickness equation of the journal part is expressed as follows:

$${h}_{J} = c ( 1 + ε cos θ ) + ( y + V Δ t ) {γ}_{j} cos ( θ - ϕ - {α}_{r} ) + {δ}_{JE} + {δ}_{JT} ;$$

in the equation, c is a radius clearance, ε represents an eccentricity, θ represents a position angle of the bearing, δ_{JE} represents elastic deformation of the journal part, δ_{JT} represents a thermal deformation of the journal part, φ is an attitude angle of a central section, γⱼ is an inclination angle of a journal of a main bearing shell; and αᵣ is an angle between the project of a journal axis and an eccentric distance;
the oil film thickness equation of the thrust part is expressed as follows:

$${h}_{T} = {h}_{p} + r sin ( {θ}_{p} ) + {δ}_{TE} + {δ}_{TT}$$

in the equation, θₚ is a circumferential inclination angle of a single shell, hₚ is an average oil clearance, r is a radial coordinate, δ_{TE} is elastic deformation, and δ_{TT} is thermal deformation,
a Reynolds equation of the journal part is expressed:

$$\frac{\partial }{\partial x} ( {ϕ}_{x} \frac{{h}_{J}^{3}}{η} \frac{\partial {P}_{J}}{\partial x} ) + \frac{\partial }{\partial y} ( {ϕ}_{y} \frac{{h}_{J}^{3}}{η} \frac{\partial {P}_{J}}{\partial y} ) = 6 ω r ( {ϕ}_{c} \frac{\partial {h}_{J}}{\partial x} σ \frac{\partial {φ}_{s}}{\partial x} ) + 12 {ϕ}_{c} \frac{\partial {h}_{J}}{\partial t} + 6 {ϕ}_{c} \frac{\partial ( ρ h )}{\partial y} + 6 V σ \frac{\partial ( ρ {ϕ}_{s} )}{\partial y} ;$$

in the equation, ϕₓ, ϕ_{y}, ϕₛ and ϕ_{c} are x-direction and y-direction pressure flow factors, a shear flow factor and a contact factor, respectively, introduced when a roughness is considered, h_{J} is oil film thickness of the journal part, η is viscosity of a lubricating medium, p_{J} is oil film pressure distribution of the journal part, η is a relative rotation of the journal and the bearing shell, V is an axial velocity of the journal, r is an inner diameter of the bearing, x is an x-direction position of the bearing, y is a y-direction position of the bearing, and t is a time.
a Reynolds equation of the thrust part is expressed:

$$\frac{\partial }{{r}_{T} \partial x} ( {ϕ}_{θ} \frac{{h}_{T}^{3}}{{r}_{T} η} \frac{\partial {P}_{T}}{\partial θ} ) + \frac{\partial }{\partial r} ( {ϕ}_{y} \frac{{h}_{T}^{3}}{η} \frac{\partial {P}_{T}}{\partial r} ) = 6 ω r ( {ϕ}_{θ} \frac{\partial {h}_{T}^{3}}{\partial θ} σ \frac{\partial {ϕ}_{s}}{\partial θ} ) + 12 {φ}_{c} \frac{\partial {h}_{T}}{\partial t} ;$$

in the equation, ϕ_{θ} and ϕᵣ are pressure flow factors in circumferential and radial directions, respectively, introduced when a roughness is considered, r_{T} is a radial position of a trust surface, h_{T} is the oil film thickness of the thrust part, p_{T} is the oil film pressure distribution of the thrust part, θ is a circumferential position of the bearing, and the rest variables are the same as those of the journal part.

Further, the heat flow continuity conditions are expressed as:

$${( v \frac{\partial {T}_{j}}{\partial z} )}_{j , m} = - {( {U}_{r} \frac{\partial {T}_{th}}{\partial r} )}_{j , m} ;$$

$$v \frac{{T}_{j , m} - {T}_{j , m - 1}}{Δ z} = {U}_{r} \frac{{T}_{j , m + 1} - {T}_{j , m}}{Δ r} ;$$

$${T}_{j , m} - \frac{{U}_{r} Δ {zT}_{j , m + 1} + v Δ {rT}_{j , m - 1}}{v Δ r + {U}_{r} Δ z} ;$$

in the equation, T_{j,m} is an oil film temperature at an interface between the journal part and the thrust part, j is a circumferential position, m is an axial position of the journal part and a radial position of the thrust part, Uᵣ is a radial flow rate of the oil film of the thrust part, v is an axial flow rate of the oil film of the journal part, Δz is an axial unit length of the journal part, and Δr is a radial unit length of the thrust part;
the thermal deformation and the elastic deformation calculated by the deformation matrix method can be expressed as:

$$\{ \begin{matrix}{δ}_{E} ( θ , z ) & = {\int }_{0}^{ROW} {\int }_{0}^{COL} {DE}_{θ , z}^{{θ}^{′} , {z}^{′}} p ( {θ}^{′} , {z}^{′} ) d θ dz \\ {δ}_{T} ( θ , z ) & = {\int }_{0}^{ROW} {\int }_{0}^{COL} {DT}_{θ , z}^{{r}^{′} {θ}^{′} , {z}^{′}} T ( {r}^{′} , {θ}^{′} , {z}^{′} ) d θ dz\end{matrix} ;$$

in the equation, COL is a number of grids in a circumferential direction, ROW is a number of grids in an axial direction, corresponding to a number of grids in a radial direction of the thrust part; DE_{θ,z}^{0′,z′} is the elastic deformation matrix, representing elastic deformation generated at a node (θ,z) by a pressure on an action unit of a node on an inner hole surface (θ′,z′) of the bearing shell; DT_{θ,z}^{0′,z′} is a thermal deformation matrix, representing thermal deformation generated at the node (θ,z) by a temperature rise of an action unit of a node (θ′,z′) of the bearing shell material; Δθ is a circumferential unit length; and Δz is an axial unit length, corresponding to a radial unit length of the thrust part;
the heat flow and pressure continuity conditions are expressed as:

$${( \frac{{h}_{J}^{3}}{12 η} \frac{\partial {P}_{hJ}}{\partial z} )}_{j , m} = {( - \frac{{h}_{T}^{3}}{12 η} \frac{\partial {P}_{hT}}{\partial r} )}_{j , m} ;$$

$$\frac{{h}_{J}^{3}}{12 η} \frac{{P}_{j , m} - {P}_{j , m - 1}}{Δ z} = \frac{{h}_{T}^{3}}{12 η} \frac{{P}_{j , m + 1} - {P}_{j , m}}{Δ r} ;$$

$${P}_{j , m} = \frac{Δ {zh}_{J}^{3} {P}_{hT ( j , m + 1 )} + Δ {rh}_{T}^{3} {P}_{hJ ( j , m - 1 )}}{Δ {zh}_{T}^{3} + Δ {rh}_{J}^{3}} ;$$

in the equation, P_{j,m} is an oil film pressure at the interface between the journal part and the thrust part, j is a circumferential position, m is an axial position of the journal part and a radial position of the thrust part, h_{T} is the oil film thickness of the thrust part, h_{J} is oil film thickness of the journal part, Δz is an axial unit length of the journal part, and Δr represents a radial unit length of the thrust part.

Further, the global parameters include, among others: (1) bearing parameters: bearing width, journal outer diameter (consistent with the corresponding bearing segment), radius clearance, initial eccentricity, initial attitude angle, roughness of the bearing shell, elastic modulus of the bearing shell, Poisson's ratio of the bearing shell and heat transfer coefficient of the bearing shell; (2) other parameters: lubricating medium density, lubricating medium viscosity. oil inlet temperature, ambient temperature, rotation speed and load; and (3) parameters of calculation methods: a number of bearing grid divisions; and convergence precision of oil film pressure of the bearing.

Further, in the S4, after obtaining the oil film load capacity through calculation, deducting the Reynolds disturbance equation under a coupled effect, solving and calculating to obtain a disturbance radial force and a disturbance axial force, and calculating the stiffness damping of each part according to a coupled stiffness damping matrix. Specifically, establishing a Reynolds disturbance equation method to solve disturbance pressures, including pressures in an axial direction, in a horizontal direction and in a vertical direction, under the stable conditions; and integrating the disturbance pressures to obtain main stiffness damping and cross stiffness damping in each direction.

Further, a Reynolds disturbance equation for calculating the coupled disturbance force is expressed as follows:

$$\frac{\partial }{R \partial θ} ( {ϕ}_{θ} \frac{{h}_{J}^{3}}{12 μ} \frac{\partial {p}_{ξ J}}{R \partial θ} ) + \frac{\partial }{\partial z} ( {ϕ}_{z} \frac{{h}_{J}^{3}}{12 μ} \frac{\partial {p}_{ξ J}}{\partial z} ) = \{ \begin{matrix}- \frac{\partial }{R \partial θ} ( {ϕ}_{θ} \frac{{h}_{J}^{2}}{4 μ} \frac{\partial {p}_{ξ J}}{R \partial θ} sin θ ) - \frac{\partial }{\partial z} ( {ϕ}_{z} \frac{{h}_{J}^{2}}{4 μ} \frac{\partial {p}_{ξ J}}{\partial z} sin θ ) + \frac{ω R}{2} cos θ : & ξ J = x \\ - \frac{\partial }{R \partial θ} ( {ϕ}_{θ} \frac{{h}_{J}^{2}}{4 μ} \frac{\partial {p}_{ξ J}}{R \partial θ} cos θ ) - \frac{\partial }{\partial z} ( {ϕ}_{z} \frac{{h}_{J}^{2}}{4 μ} \frac{\partial {p}_{ξ J}}{\partial z} cos θ ) + \frac{ω R}{2} sin θ : & ξ J = y \\ 0 : & ξ J = z \\ cos θ : & ξ J = \dot{x} \\ sin θ : & ξ J = \dot{y} \\ 0 : & ξ J = \dot{z}\end{matrix} ;$$

$$\frac{\partial }{r \partial θ} ( {ϕ}_{θ} \frac{{h}_{T}^{3}}{12 μ} \frac{\partial {p}_{ξ T}}{r \partial θ} ) + \frac{\partial }{\partial r} ( {ϕ}_{r} \frac{{h}_{T}^{3}}{12 μ} \frac{\partial {p}_{ξ T}}{\partial r} ) = \{ \begin{matrix}0 : & ξ T = x \\ 0 : & ξ T = y \\ \frac{\partial }{r \partial r} ( \frac{{rh}_{T}^{2}}{4 μ} \frac{\partial {p}_{0}}{r \partial } ) + \frac{\partial }{r \partial θ} ( {ϕ}_{r} \frac{{h}_{T}^{2}}{4 μ} \frac{\partial {p}_{0}}{r \partial θ} ) : & ξ T = z \\ 0 : & ξ T = \dot{x} \\ 0 : & ξ T = \dot{y} \\ 1 : & ξ T = \dot{z}\end{matrix} ;$$

in the equation, [symbol] corresponds to a perturbation term of the journal part, ξT corresponds to a perturbation term of the thrust part, when ξ is x, y or z, it represents a displacement disturbance term in the horizontal, vertical or axial direction, respectively, and when ξ is \dot{x}, \dot{y} or ż, it represents a velocity disturbance term in a horizontal, vertical or axial direction, respectively; and
after calculating and obtaining the disturbance pressures through the Reynolds disturbance equation, integrating the disturbance pressures, and then determining coupled oil film stiffness and damping values of each part, with the specific expression as follows:

$${K}_{J} = \int {\int }_{J} \{ \begin{matrix}- cos θ \\ - sin θ \\ 0\end{matrix} \} \{ \begin{matrix}{p}_{x} & {p}_{y} & {p}_{z}\end{matrix} \} d {Ω}_{J} = [ \begin{matrix}Kxx & Kxy & Kxz \\ Kyx & Kyy & Kyz \\ 0 & 0 & 0\end{matrix} ] ;$$

$${C}_{J} = \int {\int }_{J} \{ \begin{matrix}- cos θ \\ - sin θ \\ 0\end{matrix} \} \{ \begin{matrix}{p}_{\dot{x}} & {p}_{\dot{y}} & {p}_{\dot{z}}\end{matrix} \} d {Ω}_{T} = [ \begin{matrix}Cxx & Cxy & Cxz \\ Cyx & Cyy & Cyz \\ 0 & 0 & 0\end{matrix} ] ;$$

$${K}_{T} = \int {\int }_{T} \{ \begin{matrix}0 \\ 0 \\ - 1\end{matrix} \} \{ \begin{matrix}{p}_{x} & {p}_{y} & {p}_{z}\end{matrix} \} d {Ω}_{J} = [ \begin{matrix}0 & 0 & 0 \\ 0 & 0 & 0 \\ Kzx & Kzy & Kzz\end{matrix} ] ;$$

$${C}_{T} = \int {\int }_{T} \{ \begin{matrix}0 \\ 0 \\ - 1\end{matrix} \} \{ \begin{matrix}{p}_{\dot{x}} & {p}_{\dot{y}} & {p}_{\dot{z}}\end{matrix} \} d {Ω}_{J} = [ \begin{matrix}0 & 0 & 0 \\ 0 & 0 & 0 \\ Czx & Czy & Czz\end{matrix} ] ;$$

in the equation, K_{J} and K_{T} correspond to radial and axial stiffness, respectively, and C_{J} and C_{T} correspond to radial and axial damping.

Further, determining whether a working cycle of the internal combustion engine has been completed, calculating the journal and axial displacements of the flanged bearing according to the load at the corresponding moment and updating the calculation domain when calculation is not completed yet, where when a lubrication area between the thrust part and a thrust shoulder changer, a number of grids and the number of boundary grids need to be corrected according to a transient relative displacement, and then an interval of calculation domain is accordingly corrected. When a displacement length and a number of unit grids are not divisible, the number of updated calculation domain grids needs to be rounded up, and a unit grid size needs to be corrected accordingly. A relative position of each bearing at a next moment is taken as an input parameter of the flanged bearing journal-trust thermal elastohydrodynamic coupled lubrication module and the flanged bearing dynamics characteristic parameter calculation module to continue the calculation, and working characteristic results of the flanged bearing in the working cycle are saved when the working cycle of the internal combustion engine has been completed.

Further, in the S6, calculating the relative position of the crankshaft journal/thrust shoulder and the bearing shell at the next moment by using the three-dimensional motion equation, analyzing thermal elastohydrodynamic lubrication characteristics of a composite bearing shell at the next moment, and updating its lubrication characteristic parameters in real time;
in the process of performing the lubrication calculation at the next moment, for the journal part, a change in the radial position of the journal directly affects a lubrication eccentricity, such that a geometric clearance between the journal and the journal part is accordingly changed, and the oil film thickness is affected; at the same time, the axial velocity in the Reynolds equation is accordingly changed. For the thrust part, a change in the radial position directly affects a geometric clearance between the thrust part and the thrust shoulder, such that the oil film thickness equation is affected; at the same time, the lubrication area between the thrust part and the thrust shoulder also changes, in which case, the number of grids and the number of boundary grids need to be corrected according to the transient relative displacement, and then the interval of calculation domain is accordingly corrected. When a displacement length and a number of unit grids are not divisible, the number of updated calculation domain grids needs to be rounded up, and a unit grid size needs to be corrected accordingly.

The radial and axial displacements are solved, and the three-dimensional motion equations for the radial and axial positions at a next moment are then calculated:

$$\{ \begin{matrix}{W}_{y}^{t} + {P}_{y}^{t} * cos α + {P}_{y}^{t} * sin α = {ma}_{y}^{t} \\ {W}_{x}^{t} + {P}_{x}^{t} = {ma}_{x}^{t} \\ {W}_{z}^{t} + {P}_{z}^{t} * sin α + {P}_{z}^{t} * cos α = {ma}_{z}^{t}\end{matrix} ;$$

in the equation, Wₓ, W_{y} and W_{z} represent loads in axial, horizontal and vertical directions, respectively; Pₓ, P_{y} and P_{z} represent load capacities in axial, horizontal and vertical directions, respectively; α represents an inclination angle of the journal; and aₓ, a_{y} and a_{z} represent acceleration in axial, horizontal and vertical directions, respectively.

Further, for the flanged bearing journal-trust thermal elastohydrodynamic coupled lubrication module and the flanged bearing coupling dynamics calculation module, the global parameters are inputted into the flanged bearing journal-trust thermal elastohydrodynamic coupled lubrication module to calculate geometric oil film thicknesses at initial positions of the journal part and the thrust part according to the initial bearing position, and the corresponding Reynolds equations are adopted to calculate oil film pressures at the initial positions of the two parts, respectively;
based on the obtained pressures, the three-dimensional energy equation of each part is adopted to solve a surface temperature of the flanged bearing shell, surface temperatures of the separate journal part and the separate thrust part of the bearing shell are obtained after the convergence conditions are met, the surface temperatures of the journal part and the thrust part of the bearing shell are then corrected according to the thermal continuity conditions, and the surface temperatures considering the coupled heat flow effect of the journal part and the thrust part of the bearing shell are obtained, that is, the temperatures of the two parts are corrected according to the heat flow continuity conditions to further obtain the surface temperatures considering the coupled heat flow effect of each part of the flanged bearing;
based on the stabilized surface temperatures of the bearing shell, the thermal deformation at the node is updated, the oil film pressure of each part is also updated according to the heat flow continuity conditions and the pressure continuity conditions, and the oil film pressure distribution of each part of the flanged bearing considering the coupled heat flow effect at the given position is obtained after the convergence conditions are met, that is, the thermal deformation of the bearing shell is updated according to the surface temperatures of the bearing shell that has considered the coupled heat flow effect, and the pressure distribution is then corrected according to the heat flow continuity conditions to obtain the oil film pressure of each part that considers the coupled heat flow and pressure effects;
the axial and radial load capacities of the flanged bearing are calculated according to the pressure of each part, the position of the bearing is corrected based on the load capacities, and the above operation is repeated until the load capacities meet the load requirements, so as to obtain a stable lubrication state of the bearing at the moment; and
on the basis of obtaining the oil film pressures that give comprehensive consideration to the coupled flow, heat and pressure effects, the Reynolds disturbance equation method is adopted to solve the disturbance pressure under the stable conditions, and the integral is used to calculate the stiffness damping, that is, the Reynolds disturbance equation is adopted to solve the coupled axial disturbance force and the coupled radial disturbance force, and the disturbance pressures are integrated according to a stiffness damping definition equation, whereby coupled stiffness damping of each part is calculated to characterize the stability of the flanged bearing.

On the basis of completing the calculation of the lubrication and dynamics characteristics at the moment, the three-dimensional motion equation is adopted to calculate the relative position of the flanged bearing at the next moment, meanwhile, the lubrication calculation domain at each moment is updated according to the displacement, the number of calculation grids is accordingly corrected, and the above calculation process is repeated; and
determining whether a working cycle of the internal combustion engine has been completed, and the relative position of the flanged bearing at the next moment is taken as the input parameter to continue the calculation when calculation is not completed yet; and working characteristic results of the flanged bearing in the working cycle are inputted and saved when the working cycle of the internal combustion engine has been completed.

The various embodiments in the specification are described in a progressive manner, each embodiment focuses on differences from other embodiments, and the same and similar parts between the embodiments may refer to each other. In order to clearly illustrate interchangeability of hardware and software, compositions and steps of the various examples have been generally described in terms of functionality in the specification. Whether the functions are executed in hardware or software depends on the specific application and design constraints of the technical solution. Those skilled in the art may use different methods to implement the described functions for each particular application, but such implementation should not be considered to be beyond the scope of the present disclosure.

The above description of the disclosed embodiments enables professionals skilled in the art to achieve or use the present disclosure. Various modifications to the embodiments are readily apparent to professionals skilled in the art, and the general principles defined herein may be implemented in other embodiments without departing from the spirit or scope of the present disclosure. Therefore, the present disclosure will not be limited to the embodiments shown herein, but falls within the widest scope consistent with the principles and novel features disclosed herein.

What is claimed is:

1. A method for calculating coupled lubrication and dynamics characteristic parameters of a flanged bearing, comprising the following steps:
S1: obtaining structural parameters and operating conditions of a flanged bearing;
S2: setting a time t;
S3: calculating and obtaining oil film load capacity by using a flanged bearing journal-trust thermal elastohydrodynamic coupled lubrication module;
S4: after completing the S3, calculating stiffness damping by using a flanged bearing dynamics characteristic parameter calculation module;
S5: after completing the S4, determining whether a working cycle of an internal combustion engine has been completed by using a flanged bearing relative position feedback module, outputting and saving working characteristic parameter results of the flanged bearing when the working cycle has been completed, and directly proceeding to S6 when the working cycle is not completed yet; and
S6: calculating radial and axial displacements of the flanged bearing according to a load at the corresponding moment, updating a calculation domain and network of a thrust part, and continuing to perform calculation by taking a relative position of each bearing at a next moment as an input parameter of the flanged bearing journal-trust thermal elastohydrodynamic coupled lubrication module and the flanged bearing dynamics characteristic parameter calculation module.

2. The method for calculating coupled lubrication and dynamics characteristic parameters of the flanged bearing according to claim 1, wherein
the S3 specifically comprises: calculating oil film thicknesses of the journal part and the thrust part according to the inputted structural parameters and operating conditions of the flanged bearing;
introducing a Reynolds averaged equation that gives consideration to an axial velocity on the basis of obtaining the oil film thicknesses, solving the Reynolds averaged equation, adopting a finite difference method to calculate oil film pressure distributions of the journal part and the thrust part, and performing loop iterations until pressure convergence conditions are met, and pressure boundary conditions follow Reynolds boundary conditions;
adopting the finite difference method to solve three-dimensional energy equations of the journal part and the thrust part respectively, a heat conduction equation of a bearing shell of the same, and the boundary conditions comprise: oil inlet end temperatures of the journal part and the thrust part are given oil inlet temperatures; regarding an exterior of a bearing shell as convective heat transfer conditions with an environment; calculating heat at an oil outlet end of the journal part and heat at an inner diameter area of the thrust part according to heat flow continuity conditions; and updating in each loop iteration and performing loops until the temperature meets the convergence conditions;
adopting a deformation matrix method to calculate oil film pressure, and calculating thermal deformation at each node of the journal part and the thrust part according to the obtained oil film pressure, introducing the thermal deformation into oil film thickness equation and repeating the previous oil pressure calculation until the thermal deformation meets the convergence conditions; and
adopting an elastic deformation matrix to calculate elastic deformation at each node of the journal part and the thrust part based on the current pressure, introducing the elastic deformation into the oil film thickness equation and repeating the previous oil pressure calculation, in which case, introducing the boundary conditions: that is, the oil film pressure on an end face of a thrust side of the journal part and the oil film pressure at an inner diameter of the thrust part meet the heat flow and pressure continuity conditions, performing loop calculation until the elastic deformation meets the convergence conditions, and integrating the oil film pressures to obtain an oil film load capacity.

3. The method for calculating coupled lubrication and dynamics characteristic parameters of the flanged bearing according to claim 2, wherein
the oil film thickness equation of the journal part is expressed as follows:
$${h}_{J} = c ( 1 + ε cos θ ) + ( y + VΔ t ) {γ}_{j} cos ( θ - φ - {α}_{r} 〉 + {δ}_{JE} + {δ}_{JT} ;$$
in the equation, c is a radius clearance, ε represents an eccentricity, θ represents a position angle of the bearing, δ_{JE} represents elastic deformation of the journal part, δ_{JT} represents a thermal deformation of the journal part, φ is an attitude angle of a central section, γⱼ is an inclination angle of a journal of a main bearing shell; and αᵣ is an angle between the project of a journal axis and an eccentric distance;
the oil film thickness equation of the thrust part is expressed as follows:
$${h}_{T} = {h}_{p} + r sin ( {θ}_{p} ) + {δ}_{TE} + {δ}_{JT}$$
in the equation, θₚ is a circumferential inclination angle of a single shell, hₚ is an average oil clearance, r is a radial coordinate, δ_{TE} is elastic deformation, and δ_{TT} is thermal deformation;
a Reynolds equation of the journal part is expressed as:
$$\frac{\partial }{\partial x} ( {ϕ}_{x} \frac{{h}_{J}^{3}}{η} \frac{\partial {P}_{J}}{\partial x} ) + \frac{\partial }{\partial y} ( {ϕ}_{y} \frac{{h}_{J}^{3}}{η} \frac{\partial {P}_{J}}{\partial y} ) = 6 ω r ( {ϕ}_{c} \frac{\partial {h}_{J}}{\partial x} σ \frac{\partial {φ}_{s}}{\partial x} ) + 12 {ϕ}_{c} \frac{\partial {h}_{J}}{\partial t} + 6 V {ϕ}_{c} \frac{\partial ( ρ h )}{\partial y} + 6 V {ϕ}_{c} \frac{\partial ( ρ {ϕ}_{s} )}{\partial y} ;$$
in the equation, ϕₓ, ϕ_{y}, ϕₛ and ϕ_{c} are x-direction and y-direction pressure flow factors, a shear flow factor and a contact factor, respectively, introduced when a roughness is considered, h_{J} is oil film thickness of the journal part, η is viscosity of a lubricating medium, p_{J} is oil film pressure distribution of the journal part, ω is a relative rotation of the journal and the bearing shell, V is an axial velocity of the journal, r is an inner diameter of the bearing, x is an x-direction position of the bearing, y is a y-direction position of the bearing, and t is a time; and
a Reynolds equation of the thrust part is expressed as:
$$\frac{\partial }{{r}_{T} \partial θ} ( {ϕ}_{θ} \frac{{h}_{J}^{3}}{{r}_{T} η} \frac{\partial {P}_{T}}{\partial θ} ) + \frac{\partial }{\partial r} ( {ϕ}_{r} \frac{{h}_{T}^{3}}{η} \frac{\partial {P}_{T}}{\partial r} ) = 6 ω r ( {ϕ}_{θ} \frac{\partial {h}_{T}^{3}}{\partial θ} + σ \frac{\partial {ϕ}_{s}}{\partial θ} ) + 12 {φ}_{c} \frac{\partial {h}_{T}}{\partial t} ;$$
in the equation, ϕ_{θ} and ϕᵣ are pressure flow factors in circumferential and radial directions, respectively, introduced when a roughness is considered, r_{T} is a radial position of a trust surface, h_{T} is the oil film thickness of the thrust part, p_{T} is the oil film pressure distribution of the thrust part, θ is a circumferential position of the bearing, and the rest variables are the same as those of the journal part.

4. The method for calculating coupled lubrication and dynamics characteristic parameters of the flanged bearing according to claim 2, wherein
the heat flow and pressure continuity conditions are expressed as:
$${( \frac{\partial {T}_{J}}{\partial z} )}_{j , m} = - {( {U}_{r} \frac{\partial {T}_{th}}{\partial r} )}_{j , m} ;$$
$$v \frac{{T}_{j , m} - {T}_{j , m - 1}}{Δ z} = {U}_{r} \frac{{T}_{j , m + 1} - {T}_{j , m}}{Δ r} ;$$
$${T}_{j , m} = \frac{{U}_{r} Δ {zT}_{j , m + 1} + v Δ {rT}_{j , m - 1}}{v Δ r + {U}_{r} Δ z} ;$$
in the equation, T_{j,m} is an oil film temperature at an interface between the journal part and the thrust part, j is a circumferential position, m is an axial position of the journal part and a radial position of the thrust part, Uᵣ represents a radial flow rate of the oil film of the thrust part, v represents an axial flow rate of the oil film of the journal part, Δz is an axial unit length of the journal part, and Δr represents a radial unit length of the thrust part;
the thermal deformation and the elastic deformation calculated by the deformation matrix method can be expressed as:
$$\{ \begin{matrix}{δ}_{E} ( θ , z ) & = {\int }_{0}^{ROW} {\int }_{0}^{COL} {DE}_{θ , z}^{{θ}^{′} , {z}^{′}} p ( {θ}^{′} , {z}^{′} ) d θ dz \\ {δ}_{T} ( θ , z ) & = {\int }_{0}^{ROW} {\int }_{0}^{COL} {DT}_{θ , z}^{{r}^{′} {θ}^{′} , {z}^{′}} T ( {r}^{′} , {θ}^{′} , {z}^{′} ) d θ dz\end{matrix} ;$$
in the equation, COL represents a number of grids in a circumferential direction, ROW represents a number of grids in an axial direction, corresponding to a number of grids in a radial direction of the thrust part; DE_{θ,z}^{0′,z′} is the elastic deformation matrix, representing elastic deformation generated at a node (θ,z) by a pressure on an action unit of a node on an inner hole surface (θ′,z′) of the bearing shell; DT_{θ,z}^{0′,z′} is a thermal deformation matrix, representing thermal deformation generated at the node (θ,z) by a temperature rise of an action unit of a node (θ′,z′) of the bearing shell material; Δθ is a circumferential unit length; and Δz is an axial unit length, corresponding to a radial unit length of the thrust part; and
the heat flow and pressure continuity conditions are expressed as:
$${( \frac{{h}_{J}^{3}}{12 η} \frac{\partial {P}_{hJ}}{\partial z} )}_{j , m} = {( - \frac{{h}_{T}^{3}}{12 η} \frac{\partial {P}_{hT}}{\partial r} )}_{j , m} ;$$
$$\frac{{h}_{J}^{3}}{12 η} \frac{{P}_{j , m} - {P}_{j , m - 1}}{Δ z} = \frac{{h}_{T}^{3}}{12 η} \frac{{P}_{j , m + 1} - {P}_{j , m}}{Δ r} ;$$
$${P}_{j , m} = \frac{Δ {zh}_{J}^{3} {P}_{hT ( j , m + 1 )} + Δ {rh}_{T}^{3} {P}_{hJ ( j , m - 1 )}}{Δ {zh}_{T}^{3} + Δ {rh}_{J}^{3}} ;$$
in the equation, P_{j,m} is an oil film pressure at the interface between the journal part and the thrust part, j is a circumferential position, m is an axial position of the journal part and a radial position of the thrust part, h_{T} is the oil film thickness of the thrust part, h_{J} is oil film thickness of the journal part, Δz is an axial unit length of the journal part, and Δr represents a radial unit length of the thrust part.

5. The method for calculating coupled lubrication and dynamics characteristic parameters of the flanged bearing according to claim 1, wherein
in the S4, deducting a Reynolds disturbance equation under a coupled effect after obtaining the oil film load capacity through calculation, solving and calculating to obtain a disturbance radial force and a disturbance axial force, and calculating the stiffness damping of each part according to a coupled stiffness damping matrix.

6. The method for calculating coupled lubrication and dynamics characteristic parameters of the flanged bearing according to claim 5, wherein
the Reynolds disturbance equation for calculating the coupled disturbance force is expressed as follows:
$$\frac{\partial }{R \partial θ} ( {ϕ}_{θ} \frac{{h}_{J}^{3}}{12 μ} \frac{\partial {p}_{ξ J}}{R \partial θ} ) + \frac{\partial }{\partial z} ( {ϕ}_{z} \frac{{h}_{J}^{3}}{12 μ} \frac{\partial {p}_{ξ J}}{\partial z} ) = \{ \begin{matrix}- \frac{\partial }{R \partial θ} ( {ϕ}_{θ} \frac{{h}_{J}^{2}}{4 μ} \frac{\partial {p}_{ξ J}}{R \partial θ} sin θ ) - \frac{\partial }{\partial z} ( {ϕ}_{z} \frac{{h}_{J}^{2}}{4 μ} \frac{\partial {p}_{ξ J}}{\partial z} sin θ ) + \frac{ω R}{2} cos θ : & ξ J = x \\ - \frac{\partial }{R \partial θ} ( {ϕ}_{θ} \frac{{h}_{J}^{2}}{4 μ} \frac{\partial {p}_{ξ J}}{R \partial θ} cos θ ) - \frac{\partial }{\partial z} ( {ϕ}_{z} \frac{{h}_{J}^{2}}{4 μ} \frac{\partial {p}_{ξ J}}{\partial z} cos θ ) + \frac{ω R}{2} sin θ : & ξ J = y \\ 0 : & ξ J = z \\ cos θ : & ξ J = \dot{x} \\ sin θ : & ξ J = \dot{y} \\ 0 : & ξ J = \dot{z}\end{matrix} ;$$
$$\frac{\partial }{r \partial θ} ( {ϕ}_{θ} \frac{{h}_{T}^{3}}{12 μ} \frac{\partial {p}_{ξ T}}{r \partial θ} ) + \frac{\partial }{\partial r} ( {ϕ}_{r} \frac{{h}_{T}^{3}}{12 μ} \frac{\partial {p}_{ξ T}}{\partial r} ) = \{ \begin{matrix}0 : & ξ T = x \\ 0 : & ξ T = y \\ \frac{\partial }{r \partial r} ( \frac{{rh}_{T}^{2}}{4 μ} \frac{\partial {p}_{0}}{r \partial } ) + \frac{\partial }{r \partial θ} ( {ϕ}_{r} \frac{{h}_{T}^{2}}{4 μ} \frac{\partial {p}_{0}}{r \partial θ} ) : & ξ T = z \\ 0 : & ξ T = \dot{x} \\ 0 : & ξ T = \dot{y} \\ 1 : & ξ T = \dot{z}\end{matrix} ;$$
in the equation, [symbol] corresponds to a perturbation term of the journal part, ξT corresponds to a perturbation term of the thrust part, when ξ is x, y or z, it represents a displacement disturbance term in a horizontal, vertical or axial direction, respectively, and when ξ is \dot{x}, \dot{y} or ż, it represents a velocity disturbance term in a horizontal, vertical or axial direction, respectively; and
after calculating and obtaining the disturbance pressures through the Reynolds disturbance equation, integrating the disturbance pressures, and then determining coupled oil film stiffness and damping values of each part, with the specific expression as follows:
$${K}_{J} = \int {\int }_{J} \{ \begin{matrix}- cos θ \\ - sin θ \\ 0\end{matrix} \} \{ \begin{matrix}{p}_{x} & {p}_{y} & {p}_{z}\end{matrix} \} d {Ω}_{J} = [ \begin{matrix}Kxx & Kxy & Kxz \\ Kyx & Kyy & Kyz \\ 0 & 0 & 0\end{matrix} ] ;$$
$${C}_{J} = \int {\int }_{J} \{ \begin{matrix}- cos θ \\ - sin θ \\ 0\end{matrix} \} \{ \begin{matrix}{p}_{\dot{x}} & {p}_{\dot{y}} & {p}_{\dot{z}}\end{matrix} \} d {Ω}_{T} = [ \begin{matrix}Cxx & Cxy & Cxz \\ Cyx & Cyy & Cyz \\ 0 & 0 & 0\end{matrix} ] ;$$
$${K}_{T} = \int {\int }_{T} \{ \begin{matrix}0 \\ 0 \\ - 1\end{matrix} \} \{ \begin{matrix}{p}_{x} & {p}_{y} & {p}_{z}\end{matrix} \} d {Ω}_{J} = [ \begin{matrix}0 & 0 & 0 \\ 0 & 0 & 0 \\ Kzx & Kzy & Kzz\end{matrix} ] ;$$
$${C}_{T} = \int {\int }_{T} \{ \begin{matrix}0 \\ 0 \\ - 1\end{matrix} \} \{ \begin{matrix}{p}_{\dot{x}} & {p}_{\dot{y}} & {p}_{\dot{z}}\end{matrix} \} d {Ω}_{J} = [ \begin{matrix}0 & 0 & 0 \\ 0 & 0 & 0 \\ Czx & Czy & Czz\end{matrix} ] ;$$
in the equation, K_{J} and K_{T} correspond to radial and axial stiffness, respectively, and C_{J} and C_{T} correspond to radial and axial damping.

7. The method for calculating coupled lubrication and dynamics characteristic parameters of the flanged bearing according to claim 1, wherein
in the S6, calculating the relative position of the crankshaft journal/thrust shoulder and the bearing shell at the next moment by using the three-dimensional motion equation, analyzing thermal elastohydrodynamic lubrication characteristics of a composite bearing shell at the next moment, and updating its lubrication characteristic parameters in real time; and
solving the radial and axial displacements, and further calculating the three-dimensional motion equations for the radial and axial positions at a next moment:
$$\{ \begin{matrix}{W}_{y}^{t} + {P}_{y}^{t} * cos α + {P}_{y}^{t} * sin α = {ma}_{y}^{t} \\ {W}_{x}^{t} + {P}_{x}^{t} = {ma}_{x}^{t} \\ {W}_{z}^{t} + {P}_{z}^{t} * sin α + {P}_{z}^{t} * cos α = {ma}_{z}^{t}\end{matrix} ;$$
in the equation, Wₓ, W_{y} and W_{z} represent loads in axial, horizontal and vertical directions, respectively; Pₓ, P_{y} and P_{z} represent load capacities in axial, horizontal and vertical directions respectively; α represents an inclination angle of the journal; and aₓ, a_{y} and a_{z} represent acceleration in axial, horizontal and vertical directions, respectively.
